(19) United States
(12) Patent Application Publication
(10) Pub. No.: US 2015/0178479 A1
(43) Pub. Date: Jun. 25, 2015

(54) Transmission of a Digital Content Between a Source Terminal and a Recipient Terminal

(71) Applicant: Orange, Paris (FR)

(72) Inventor: Bastien Lamer, Meudon (FR)

(21) Appl. No.: 14/415,800

(22) PCT Filed: Jul. 16, 2013
(86) PCT No.: PCT/FR2013/051711

§ 371 Date: Jan. 20, 2015

(30) Foreign Application Priority Data
Jul. 20, 2012 (FR) 1257053

(51) Int. Cl. G06F 21/10

(52) U.S. Cl. CPC G06F 21/10; G06F 2221/0724

(57) ABSTRACT

A method is provided for transmission, between a source terminal and at least one first recipient terminal, of digital content containing a datum representing a number of authorized loans of the digital content by the source terminal. The method includes the following steps: modification of the digital content including insertion, by the source terminal, into the digital content, of a datum representing a number of authorized loans of the digital content by the first recipient terminal, which is lower than the number of authorized loans of the digital content by the source terminal; and transmission of the modified digital content to the at least one recipient terminal.

### 1. CROSS-REFERENCE TO RELATED APPLICATIONS

This application is a Section 371 National Stage Application of International Application No. PCT/FR2013/051711, filed Jul. 16, 2013, which is incorporated by reference in its entirety and published as WO 2014/013189 on Jan. 23, 2014, not in English.

### 2. FIELD OF THE INVENTION

The field of the invention is that of novel techniques of information and communications relating to the dissemination of digital contents.

More specifically, the invention relates to a technique for transmitting a digital content between a source terminal and a recipient terminal, said technique for transmitting resulting from a wish to lend or loan items between two users.

The invention has numerous applications, especially when it is implemented in the context of a system for lending or loaning digital books, audio files or video files.

### 3. TECHNOLOGICAL BACKGROUND

Providers of digital contents (electronic books, audio files, video files, etc) and entitled users most generally protect these contents in order to prevent them from being freely accessible and to prevent any user from benefiting from them without having preliminarily acquired rights.

To this end, these providers use digital rights management (or DRM) techniques based especially on the use of techniques of digital watermarking, code obfuscation or cryptographic techniques that prevent for example the copying of a digital content and its dissemination to third parties.

Thus, a user who has “purchased” a digital content is often incapable of sharing it with his family and friends through a loan for example, as is normally possible with physical objects (for example the loan of a physical book, a CD, etc).

To overcome this problem, there is method described in the prior art document UST1T102009 enabling a user to loan a digital content that he owns to a third party through a centralized management system. In the technique described in this document UST1T102009, a user informs a server that he is loaning a document in his possession to a third party. The server takes responsibility for managing the loans. This makes it possible, according to this known technique, to preserve a right to oversee the sharing operation and to resell the content to the beneficiary user of the loan (if necessary).

However, one drawback of such a technique lies in the fact that personal information on third parties (email addresses, telephone numbers, etc) has to be provided to the centralized management system. Now, the third parties do not necessarily wish their personal data to be known or to be available to a centralized management system.

Another drawback of such a technique lies in the fact that the third parties benefiting from the loan of the digital contents cannot in turn loan the digital content as the case with a physical content. Now experience, especially with musical files, shows that the fact of not being able to loan legally purchased files is firstly an obstacle to the massive adoption of this technology and secondly encourages hacking and theft of files. It is therefore necessary to provide a solution that does not have the drawbacks of the prior art, namely a solution that enables a loan while preventing personal data from being furnished and preserving an author's copyright.

### 4. SUMMARY OF THE INVENTION

The invention does not comprise these drawbacks of the prior art.

More particularly, the invention relates to a method for transmitting a digital content between a source terminal and at least one first recipient terminal, the digital content containing a piece of data representing a number of authorized loans of the digital content by the source terminal. According to the invention, the method comprises the following steps:
modifying the digital content, this step comprising the insertion by the source terminal, into said digital content, of a piece of data representing a number of authorized loans of the digital content by the first recipient terminal, smaller than the number of authorized loans of the digital content by the source terminal; and
transmitting the modified digital content to said at least one first recipient terminal.

Thus, contrary to the methods of the prior art, the invention enables the entire management of a sequence of successive loans of digital contents at the terminals, without recourse to a third-party server, thus providing firstly for the protection of the author's copyright according to the legislation in force and secondly ensuring the anonymity of the user to whom the content is loaned.

According to one particular characteristic, the digital content is received preliminarily from a contents server, the number of authorized loans of the digital content by the source terminal being determined by said contents server.

Thus, the digital content editor can set a limit on the number of possible loans of this content, for example according to the type of transaction made with the source terminal.

According to one particular characteristic, the number of authorized loans of the digital content by the first recipient terminal corresponds to the number of authorized loans of the digital content by the source terminal minus the number of recipient terminals to which the modified digital content is transmitted.

The number of loans of the content is thus controlled in order to limit its distribution during different successive loans between terminals.

According to one particular characteristic, the number of authorized loans of the digital content by the first recipient terminal is a number of loans fixed by means of the source terminal.

The user of the source terminal can thus set an arbitrary number of authorized loans to be made by the user to whom he loans the digital content, or can even decide to prevent any loans by this user.

According to one particular embodiment, in which the digital content is memorized in the source terminal, the piece of data representing a number of authorized loans of the digital content by the source terminal is modified, in the memorized digital content, according to the number of recipient terminals to which the modified digital content is transmitted and/or the number of authorized loans of the digital content by the first recipient terminal.

Thus, the number of possible loans is also limited at the source terminal in order to limit the unauthorized proliferation of the digital content from this source terminal.

According to one particular characteristic, the modification of the digital content also comprises the insertion, within said digital content, of a period of loan of the content, the first recipient terminal blocking access to the received content upon expiry of said period of loan.

It is thus possible to place a time limit on the loan of a content to another user.

According to one particular characteristic, the modification of the digital content also comprises the insertion, within said digital content, of an identifier of the digital content and of an identifier of a first recipient terminal, the first recipient terminal giving access to the modified digital content according to said identifier of the first recipient terminal.

It is thus possible to ensure that the digital content is accessible only to the user to whom it is loaned.

According to one particular embodiment, the modification of the digital content also comprises the insertion, within said digital content, of an identifier of the source terminal, the method furthermore comprising the transmission to the source terminal of a notification of termination of the loan by means of said identifier of the source terminal.

Thus, a number of authorized loans can be reallocated to the source terminal when a recipient terminal does not use either the digital content that is loaned to it or the possibility of loaning it to other terminals.

According to one particular characteristic, the notification of termination of the loan is a message comprising the modified digital content.

This makes it possible, when the digital content cannot only be loaned once, to return the digital content to the source terminal so that this source terminal can again access this content.

According to one particular embodiment, the insertion of the data representing a number of authorized loans of the digital content by the first recipient terminal consists in replacing, within the digital content, the piece of data representing a number of authorized loans of the digital content by the source terminal, by said piece of data representing a number of authorized loans of the digital content by the first recipient terminal.

Thus, each terminal can directly and unambiguously access the number of authorized loans of the digital content that it can manage at its level.

According to one particular embodiment, said modified digital content is transmitted by the first recipient terminal to at least one second recipient terminal according to the piece of data representing a number of authorized loans of the digital content by the first recipient terminal.

Thus, the invention enables the digital content to be made to travel in transit through a relay user. The invention thus enables the technical reproduction of a classic loan scheme in which a loaning party loans a content to a person but does so in making this content travel in transit via a user who is known both to the loaning party and to the recipient.

The invention also relates, in at least one embodiment, to a method for the retransmission, by a first recipient terminal, of a digital content received from a source terminal, said digital content containing a piece of data representing a number of authorized loans of said digital content by the first recipient terminal.

According to the invention, the method comprises the following steps:
obtaining, by the first recipient terminal, from said digital content, of said number of authorized loans of said digital content by the first recipient terminal; and
transmitting the digital content to at least one second recipient terminal as a function of said number of authorized loans of said digital content by the first recipient terminal.

According to one particular embodiment, the first recipient terminal sends the source terminal a request for authorizing the loan, the modified digital content being transmitted to the second recipient terminal only following the reception, by the first recipient terminal, of a positive message of response to said request.

This enables the user of a terminal loaning the digital content to another user to oppose any subsequent loan by this other user, if he deems it to be necessary.

The invention also relates to a terminal called a source terminal for transmitting a digital content at least one first recipient terminal, the digital content containing a piece of data representing a number of authorized loans of the digital contents by the source terminal, this terminal comprising:
means for modifying the digital content comprising means of insertion, within said digital content, of a piece of data representing a number of authorized loans of the digital content by the first recipient terminal that is smaller than the number of authorized loans of the digital content by the source terminal; and
means for transmitting the modified digital content to said at least one first recipient terminal.

The invention furthermore relates to a terminal, called a relay terminal, for the retransmission to at least one recipient terminal, of a digital content received from a source terminal containing a piece of data representing a number of authorized loans of said digital content by said relay terminal comprising:
means for obtaining, from the received digital content, the number of authorized loans of said digital content by the relay terminal; and
means for transmitting the digital content to said at least one recipient terminal, as a function of said number of authorized loans of said digital content by the relay terminal.

In another embodiment, the invention also relates to a system for transmitting digital contents comprising the above source terminal and relay terminal.

The invention also pertains to a computer program comprising instructions for implementing a method for transmitting or a method for retransmitting as presented here above, when this program is executed by a processor.

The invention is also aimed at providing an information medium, readable by a data processor and comprising instructions of a computer program as mentioned here above.

### 5. LIST OF FIGURES

FIG. 1 is a schematic view of one embodiment of the invention in which a digital content is shared by a plurality of terminals, through the implementation of steps of methods for transmitting and receiving according to the present invention; and

FIG. 2 provides a schematic view of another example of sharing of a digital content according to the present invention.

### 6. DETAILED DESCRIPTION

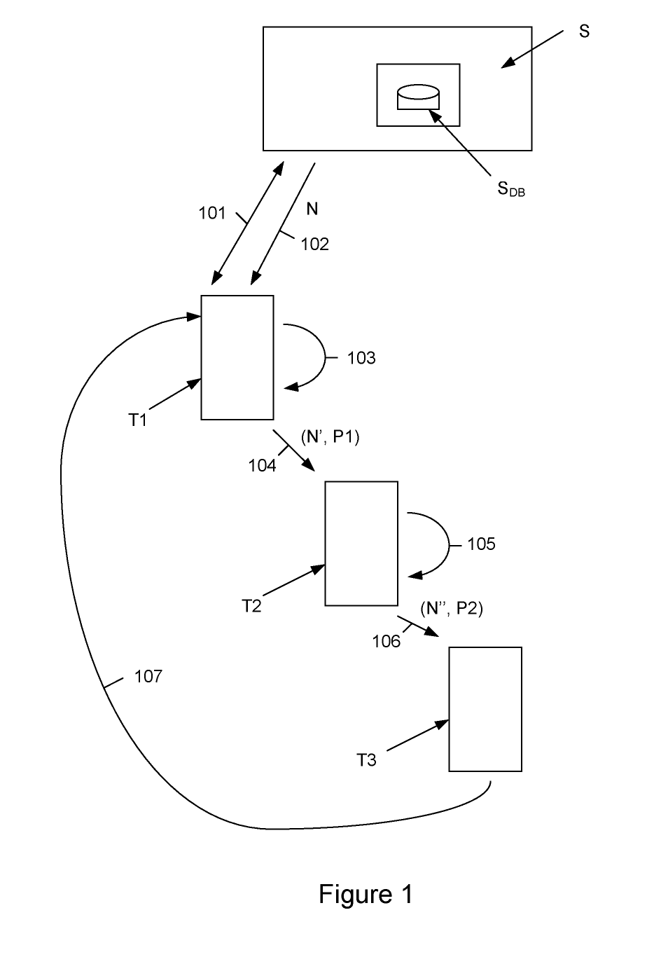

The present invention refers first of all to FIG. 1 which schematically presents one embodiment of the invention in which a digital content is shared among several users through successive loans between their terminals. Referring to this FIG. 1, we present the different steps that enable the implementation of the invention and especially the calculation of the number of authorized loans of a digital content at each of the terminals involved.

The system involved in this embodiment of the invention comprises especially a server S of digital contents, containing a database S_{BD} in which different digital contents are stored as well as three terminals T1, T2 and T3. However, the invention is not limited to such a number of terminals.

The term “digital content” is herein understood to mean any digital element comprising firstly payload content such as an electronic book, an audio file (for example in the mp3 format), a video file (for example in the mpeg, avi or other format), this list being not exhaustive, and secondly data associated with this payload content (i.e. metadata such as for example the identity of the owner of the payload content) all in the form of digital data. In particular, the payload content is used by the user of a terminal while the associated data is used by the terminal of this user.

Each of the terminals can for example be a Smartphone or an ebook reader comprising integrated communications means and comprising, in addition to the transmission means enabling communications between the different terminals, a computation unit, a random-access memory and a read-only memory enabling the execution of a software application dedicated to the loaning of digital contents between terminals. This software application manages the working of the terminals in the context of the loaning method explained here below. This software application can be downloaded and installed preliminarily by these terminals.

The server S initially provides (step 102) a digital content to the user of a terminal T1 called a “source” terminal following a transaction with this server S for purchasing (or hiring) this content (step 101).

This digital content can be read and loaned only by means of the software application installed in the terminals T1, T2 and T3. In other words, this software application can block both the reading of the content and the possibility of transmitting it to another terminal as shall be seen here below.

The digital content transmitted from the server S to the source terminal T1 contains especially a piece of data representing a number N of authorized loans of said digital content by the source terminal T1 (this piece of data possibly being this number N as such) inserted by the server S into the digital content transmitted to the source terminal T1.

In this embodiment, this number N of authorized loans is inserted into a specific data field of the digital content. In one variant, this number N of authorized loans is inserted into the digital content according to an obfuscation technique. Steganographic techniques combined with cryptographic techniques can be implemented to ensure the protection of this piece of data and especially prevent an unauthorized modification of this data.

This integer N is determined at the contents server S, for example by the editor of the digital content acquired by the source terminal T1, and corresponds to a maximum number of loans of the digital content that the source terminal T1 can make to other terminals.

This particular case where N=0 corresponds to the case where the contents editor does not permit the user of the source terminal T1 to loan this digital content. The particular case where N=1 corresponds to the case where the contents editor permits the user of the source terminal T1 to loan this content to only one other user at a time and so on and so forth.

All the digital content, and especially the number N of authorized loans, can be transmitted in encrypted form to the terminal T1 so that the number N of permitted loans is accessible only through the software application executed by the terminals, the user of the terminal T1 having access to this type of information only through this software application.

When the digital content is hired from a terminal T1 by the terminal T1+1, this content can furthermore include information relating to a duration of hire (and especially information by which the digital content can be made unavailable once the duration of hire has been expired) that can be encrypted if necessary.

Once received by the source terminal T1, the digital content can thus be made available to the user of the terminal T1 (so that he can view it, listen to it, etc) by means of the software application installed in this terminal.

Besides, the source terminal T1 receiving the digital content acquired from the server S retrieves the piece of data, within the digital content, that represents the number N of loans authorized at this terminal T1 by means of the software application executed by this terminal, which thus obtains knowledge of the number N of loans authorized at terminal T1.

This operation can be carried out by reading this piece of representative data within the digital content or within metadata associated with this digital content, typically by extracting this piece of representative data from a field of data of the digital content specifically reserved for this type of information. As an alternative, it is possible to decrypt the piece of data representing this number N of authorized loans when it is present in the digital content in the form of a piece of encrypted information.

If the number N of authorized loans obtained is zero, the user of the source terminal T1 then cannot loan the digital content. Thus, when it detects such a number N=0 of authorized loans, the software application blocks the transmission of this digital content to any other recipient terminal. This example characterizes the acquisition of a digital content accessible only to the user of the terminal T1.

In the example where the number N of authorized loans at the terminal T1 is greater than or equal to 1, the software application installed in the source terminal T1 then permits this source terminal to transmit this digital content to another (or even to several) terminals, known as “recipient” terminals, on which the software application is also installed, in doing so according to the number N of loans authorized. In other words, the software application authorizes the user of the terminal T1 to loan the digital content to a certain number of users within the limit of the number N of authorized loans and as a function of the number of authorized loans that he wishes to allocate to the users to whom he loans the content.

Thus, in another example where N=1, the user of the source terminal T1 can loan the digital content to only one other user at a time without this other user being able in turn to loan this content. However, if for example N=6, the user of the source terminal T1 can then either loan six versions of the digital content at the same time to different acquaintances of his choice (each having available a recipient terminal in which the software application is installed) without granting them the possibility of loaning the content, or he can loan the digital content to the user of one recipient terminal in granting him the possibility, in turn, of loaning this content a certain number of times, this number being limited by the number of unused authorized loans (in this case a maximum of five possible authorized loans).

The software application installed in the source terminal T1 thus limits the loan in keeping updated a database stored in the random-access memory of the source terminal T1. For each content of a set of digital contents that can be loaned by this terminal T1, this database can then include an identifier of this content, the number N of authorized loans for this content, a piece of information on status indicating whether this content is ready, as well as an identifier of a recipient terminal to which this content is loaned (for example the telephone number of this terminal) when this is the case.

Such a database can thus take the form of the following Table 1 here below:

| Identifier of | Number N of | Status of the | Identifier of the |
|---|---|---|---|
| the content | authorized loans | contents | recipient terminal |
| 1234 | 4 | Not loaned | |
| 1235 | 3 | Loaned | Tel_num_T2, Tel_num_T3 |
| 1236 | 2 | Loaned | Tel_num_T2 |
| 1236 | 2 | Loaned | Tel_num_T3 |

This description now takes the particular case where N=2, i.e. the case where the editor permits the source terminal T1 to manage two loans of the digital content. In this case, the user of the source terminal T1 can loan this content to two different users without granting them the possibility of loaning this content in turn, or else he can loan this content to only one user in granting him the possibility of loaning this content to another user. Here below that the user of the terminal T1 is deemed to be choosing the second possibility.

When the user of the source terminal T1 decides to loan the digital content to the user of the recipient terminal T2, then in a first stage the software application installed in the second terminal T1 modifies (step 103) the digital content to be loaned by inserting therein a piece of data on the number N′ of authorized loans of this content to be made by the recipient terminal T2. In order to limit the dissemination of the digital content, this number N′ of authorized loans at the terminal T2 is strictly smaller than the number N of authorized loans at the terminal T1.

The number N′ of authorized loans of the content by the recipient terminal T2 can advantageously be inserted, within the modified digital content, to replace the number N of authorized loans of the content by the source terminal T1 (especially when this number N is inserted into an easily identifiable field of the digital content), since the knowledge of this number N is not necessary for the recipient terminal T2.

This number N′ is computed by the software application of the source terminal T1 in taking account of the number N of authorized loans at the source terminal T1, which constitutes a limit not to be crossed, as well as possibly the wishes of the loaning user of the source terminal T1 on whether to allow (or not allow) the user of the recipient terminal T2 to loan the digital content in turn.

In particular, this number N′ can be equal to the number N of authorized loans of the digital content by the source terminal T1 minus the number of recipient terminals to which the modified digital content is transmitted by the terminal T1. Thus, to take up the above example of N=6, when the content is loaned to three recipient users, then N′=6−3=3. This means that the recipient users of the loan could in turn loan this content three times.

In one variant, this number N′ can be a number of loans fixed by means of an interface of the source terminal T1, strictly smaller than the number N of authorized loans at the source terminal, enabling the user of the source terminal T1 to decide how many authorized loans he wishes to allocate to the recipient terminal to which he loans the content. This interface can be proposed to the user by the software application when it decides to loan the content in informing him of the number N and proposing that he choose a number N′ strictly smaller than this number N. In particular, when the user of the source terminal T1 does not wish to allocate a possibility of a loan to the user of the recipient terminal T2 to whom he wishes to loan the content, he can set a number N′ of authorized loans equal to zero.

The new number N′ of authorized loans is kept in memory in the source terminal T1 either in a modified version of the digital content which is stored in the source terminal T1 or in the software application itself of the source terminal T1 or even in both these forms.

This makes it possible firstly to be able to modify the number of loans authorized thereafter, for example when the duration of a loan granted to a recipient terminal has expired. In addition, this makes it possible to take account, at the source terminal T1, of the limits on the number of authorized loans generated by loans already made to other recipient terminals. Thus, in loaning the digital content to another user N′=1, the number of subsequent authorized loans of the digital content by this source terminal T1 is limited to N′=1 just as in the case of this other user.

During the step 103 for preparing the modified digital content to be transmitted to the recipient terminal T2, the software application installed in the source terminal T1, can insert the following loan parameters into this content in addition to the number N′:
the identifier of the digital content (e.g. “1234”),
an identifier of the source terminal T1 (e.g. the telephone number “Tel_Num_T1”),
an identifier of the recipient terminal T2 (e.g. the telephone number “Tel_Num_T2”),
the status of the digital content (e.g. personal consultation or loan),
a period P1 of loan of the document (for example four weeks).

Some of this data can be inserted into the digital content in the form of a tag that can be constituted as follows: “tag=1234/Num_tel_T1/Num_tel_T2/status”. This data is accessible only to the software application of a recipient terminal without the user of this recipient terminal being capable of having access thereto, in order to prevent this user from possibly misusing this tag.

Once the digital content is modified by the software application, a version of this modified content can be re-encrypted by this software application so as to make it inaccessible. This version can be stored with the above-mentioned parameters and in non-encrypted form in the source terminal T1 to replace the digital content received from the server S, so as to withdraw the right of consultation from the user of the source terminal T1. This right of consultation can be returned at the end of a loan period P1 inserted into the modified content.

At this stage, it is possible to memorize the digital content in the source terminal with the data representing the number N of authorized loans of the digital content by the source terminal.

This piece of data can be modified according to the number of recipient terminals to which the modified digital content is transmitted, the number N′ of authorized loans of the digital content by the first recipient terminal, or even these two factors. In particular, the number N of authorized loans of the digital content by the source terminal can be reduced by the number of recipient terminals to which the modified digital content is transmitted by the source terminal T1 and the number N′ of authorized loans of the digital content by the first recipient terminal T2.

Thus, when the user of the source terminal wishes to again loan this digital content, he has available a number of possible loans remaining that is limited according to the number of loans he has already assigned to other users.

The source terminal T1 then transmits the modified content containing the number N′ and certain of the above-mentioned loan parameters (especially the loan period P1) to the recipient terminal T2 (step 104) which carries out the loan of this content to the user of this recipient terminal.

When the recipient terminal T2 receives the modified digital content coming from the source terminal T1, the software application installed in this terminal T2 can initially decrypt it if the content has been encrypted by the source terminal T1 so as to make it a consultable by the user of the terminal T2.

The software application of the terminal T2 then retrieves the number N′ of loans authorized at this terminal T2 as well as loan parameters if any inserted into the modified digital content, including especially the loan duration P2 during which the application makes this content accessible on the terminal T2 and stores these elements in its own database, similar to the database presented previously for the terminal T1.

The software application of the terminal T2 then checks to see whether or not the digital content can be loaned to another recipient terminal according to the number N′, similarly to what is done with the number N at the source terminal T1. It informs the user of this possibility.

If the user of the recipient terminal T2 decides in turn to loan the digital content that the user of the source terminal T1 has loaned to him to this other recipient terminal and if it is possible for him to do so (i.e. if N′>0), then the software application installed in this terminal determines a new number N″ of authorized loans of the content for this other recipient terminal T3 and modifies the digital content in order to insert therein this number N″ of authorized loans in addition to certain of the loan parameters referred to here above (step 105). A new loan period P2 can also be inserted, the expiry of which is computed so as to take place before the expiry of the period P1 in order to prevent the limit on the number of authorized loans from being improperly circumvented. For example, for a loan period P1 allocated to the terminal T2 of four weeks, a loan period P2 of two weeks can be chosen when the user of the terminal T2 decides to loan the content at the end of one week.

The terminal T2 then sends this other recipient terminal T3 this digital content modified according to one of the techniques for modifying the number of authorized loans presented here above (step 106).

Cascaded loans between terminals can thus be made. Indeed, in the example where the recipient terminal T2 can in turn grant a loan of the digital content following the obtaining of a number of authorized loans present in the received digital content, this terminal T2 can transmit a digital content that is again modified, and so on and so forth.

Thus, in the present case, since the user of the terminal T2 is able to loan the content once (i.e. N′=1), he can send the terminal T3 (transmission step 106) a version of this digital content, modified according to any one of the above techniques for modifying the number of authorized loans. In this version, there will be inserted a new number N″ of authorized loans at this terminal T3 (here N″=0) and loan parameters, especially a loan period P2.

Here below, the loan of the digital content to the recipient terminal T3 can expire at a certain time, either upon the expiry of the loan period P2 when such a period has been defined by the recipient terminal T2 or when the user of the terminal T3 decides to no longer consult this received digital content and not to loan this content, thus releasing authorized loans. This is naturally the same for the content loaned to a recipient terminal T2 by the source terminal T1.

Thus, in a first example where only the software application of the terminal T3 detects the expiry of the loan period P1, this software application then makes this content inaccessible at this terminal T3, by encrypting it in order to make it unreadable or by erasing it from the terminal T3.

Furthermore, inasmuch as the software application of the source terminal T1 has truly inserted an identifier of the terminal T1, such as a telephone number of the terminal or an address in the content, the terminal T3 then uses this identifier to send (step 107) a notification of termination of the loan by the source terminal T1 in order to inform it that the user of the terminal T3 is releasing the digital content that he has borrowed.

This notification of loan termination can consist of a simple message indicating the end of the loan of the digital content at the terminal T3 or by a message containing the loaned digital content, possibly re-encrypted before transmission, in order to return it directly to the source terminal T1.

In the latter case, a specific termination tag can be inserted into the digital content returned to the source terminal T1 (for example “tag=1234/Num_tel_T1/Num_tel_T3loan=2” inserted in the digital content sent back from T3 to T1), in order to inform the source terminal T1 that this content is truly a returned content. As an alternative, if the terminal T2 has inserted such an identifier of the terminal T2 into the content loaned to the terminal T3, the terminal T3 can return this content to this terminal T2 by inserting a similar termination tag (for example “tag=1234/Num_tel_T2/Num_tel_T3/loan t=1”) into the digital content which is then transmitted to the terminal T2 to inform it of the release of this content by the terminal T3.

When the source terminal T1 receives this rendered content, it first of all verifies that this content truly belongs to it by retrieving the identifier of this content and verifying that this identifier is truly stored in its database. If the loan of this content has led to the inaccessibility of this content at the source terminal T1, this terminal can then make this content again accessible (for example by decrypting the digital content).

In another example where the software applications of the two terminals T2 and T3 detect the expiry of the loan at the terminal T3, the digital content is then still made inaccessible (encrypted or erased) at the terminal T3 while at the terminal T2 the software application updates the number N of authorized loans by increasing it by the number of authorized loans thus released by the terminal T3 in order to enable other possible loans by the terminal T2. In addition, when the loan of the content to the terminal T3 has led to the inaccessibility of the content in the terminal T2, this content can be again made accessible by the software application installed in the terminal T2.

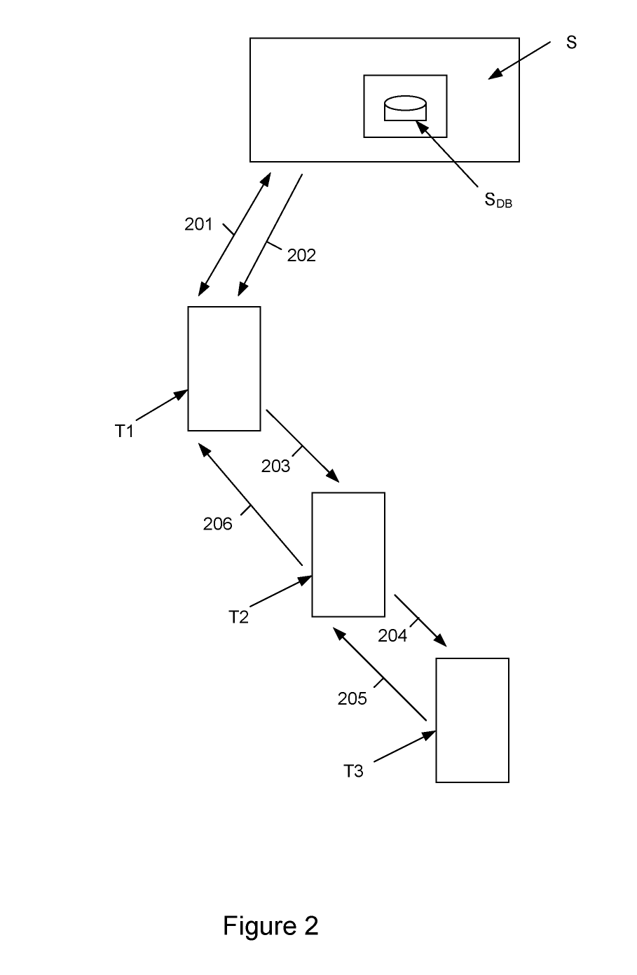

FIG. 2 illustrates another example of successive loans of a digital content involving the same three terminals T1, T2 and T3.

In this example, the user of the terminal T1 has acquired (step 202) a digital content with the possibility of loaning this digital content ten times (i.e. N=10), following a transaction (step 201) with the contents server S.

He decides in a first phase T3 to loan this content to the user of a terminal T2, in furthermore granting him the possibility of loaning this digital content four times.

The software application installed in the terminal T1 then creates a modified version of the digital content into which it inserts a new number N′=4 of authorized loans for the terminal T2, before transmitting this modified content to the terminal T2. It can additionally insert therein a loan period P1, for example a period of four weeks. In addition, this software application memorizes another modified version of the digital content in which the number N of loans authorized this time at the terminal T1 is updated to be equal to N=10−1−4=5 authorized loans, in taking account of the loan made to the terminal T2 as well as four loan possibilities that are allocated to it.

Thereafter, during a second phase 204, the user of the terminal T2 who has received the modified digital content from the terminal T1 decides in turn to loan this content to the user of another terminal T3 in furthermore granting him the possibility of loaning the transmitted digital content only once.

The software application installed in the terminal T2 then creates a modified version of the digital content into which it inserts a new number N″=1 of authorized loans for the terminal T3, and then transmits this modified version of the content to the terminal T3. It can furthermore insert therein a loan period P2, expiring before the loan period P1, for example equal to two weeks. In addition, this software application preserves in memory another modified version of the digital content in which the number N′ of authorized loans for this terminal T2 is updated to be equal to N′=4−1−1=2 authorized loans.

Once the digital content received by the terminal T3 becomes available again (either because the user of this terminal decides to no longer consult this received digital content and not to loan this content, or at the expiry of the load duration P2 for this content), a third phase 205 takes place. In this third phase, the terminal T3 informs the terminal T2 that this loan content has been made available and that loans have been authorized at the terminal T3. The terminal T3 does so for example in the form of a message for updating the number N′ memorized in the terminal T2 or by rendering the loaned digital content. Following this, the software application for the terminal T2 updates the number N′ of authorized loans at the terminal T2 by again increasing it, this number N′ herein then passing to N′=2 to N′=4, if no other loan has been granted in the meantime by the user of the terminal T2.

Subsequently, when the digital content received by the terminal T2 again becomes available in turn (for example upon expiry of a loan period P1 for this content), a fourth phase 206 takes place during which the terminal T2 informs the terminal T1 that the loaned content has again been made available along with the loans authorized at the terminal T2. The terminal T2 does so in the form of a message for updating the number N memorized in the terminal T1 or by rendering the loaned digital content. As a consequence, the software application of the terminal T1 updates the number N of authorized loans at the terminal T1 by again increasing it, this number N then going from N=5 to N=10, again inasmuch as no other loan has been granted in the meantime by the user of the terminal T1.

The different phases mentioned here above and the progress of the number N, N′, N″ of authorized loans allocated respectively to the terminals T1, T2 and T3 are illustrated in the Table 2 here below:

| | Terminal T1 | Terminal T2 | Terminal T3 |
|---|---|---|---|
| | Number N of | Number N′ of | Number N″ of |
| Phase | authorized loans | authorized loans | authorized loans |
| 202 | 10 | 0 | 0 |
| 203 | 5 | 4 | 0 |
| 204 | 5 | 2 | 1 |
| 205 | 5 | 4 | 0 |
| 206 | 10 | 0 | 0 |

It can clearly be seen in this table that at each phase of this mechanism of successive loans, the total number of loans really made and the authorized loans allocated to the different terminals remains equal to the number N fixed at the outset by the contents server S, and therefore that the proliferation of digital contents is controlled.

According to one variant, in the case of cascaded loans of digital contents, the initial loaning party of the source terminal T1, the owner of the digital content, can oppose the granting of a loan by setting up a system of sending back information before a loan of a digital content is put into effect.

Thus, for example, when a first recipient user (i.e. the user of the first recipient terminal T2) wishes to loan the content received to another recipient user (that of the second recipient terminal T3), the terminal T2 of the first user, prior to the loan, transmits a loan authorization request (by email or SMS) to the source terminal T1 of the digital content owner. This loan authorization request can optionally contain a request for loaning the digital content a number of times greater than the number N′ of possible loans by the terminal T2 within the limit of the number N of possible loans by the source terminal T1 in order to make a special exception as regards a limit on possible loans assigned to the first recipient terminal T2, provided that the user of the source terminal T1 agrees to it.

The software application of the source terminal T1 retrieves this message and offers the loaning party user the possibility of opposing this new loan by sending the terminal T2 a negative response message to the loan request. If the user is opposed to this loan then, following the reception of this negative response message, the software application installed in this terminal T2 blocks the transmission of this content to the terminal T3.

If not, if the message of response to this loan request is positive, the software application installed in the terminal T2 authorizes the transmission of the digital content to the second recipient terminal T3. Should the first recipient terminal T2 have also asked for authorization to loan the content a number of times greater than the number N′ allocated to it, this positive response message can contain an indication of the maximum number (ranging from N′ to N) of possible loans that the source terminal T1 grants the recipient terminal T2.

To this end, for example the technique described implements mechanisms of communication from one entity to the next enabling a request to the initial loaning terminal for authorization to read contents. By extension, it can be said that, in this variant, a peer-to-peer communication system enables the transmission of authorizations for reading contents from an initial proprietor while ensuring anonymity of the recipient users with to the communications network (this is relative anonymity, since each user is identified at least from the terminal that has granted him the loan).

Although the present disclosure has been described with reference to one or more examples, workers skilled in the art will recognize that changes may be made in form and detail without departing from the scope of the disclosure and/or the appended claims.

1. A method comprising:
transmitting a digital content between a source terminal and at least one first recipient terminal, the digital content containing a piece of data representing a number of authorized loans of the digital content by the source terminal, wherein transmitting comprises:
modifying the digital content, comprising insertion by the source terminal, into said digital content, of a piece of data representing a number of authorized loans of the digital content by the first recipient terminal, which is smaller than the number of authorized loans of the digital content by the source terminal; and
transmitting the modified digital content to said at least one first recipient terminal.

2. The method according to claim 1, wherein the digital content is received preliminarily from a contents server, the number of authorized loans of the digital content by the source terminal being determined by said contents server.

3. The method for transmitting according to claim 1, wherein the number of authorized loans of the digital content by the first recipient terminal corresponds to the number of authorized loans of the digital content by the source terminal minus a number of recipient terminals to which the modified digital content is transmitted by the source terminal.

4. The method for transmitting according to claim 1, wherein the number of authorized loans of the digital content by the first recipient terminal is a number of loans fixed by the source terminal.

5. The method for transmitting according to claim 1, wherein the digital content is memorized in the source terminal, and the piece of data representing a number of authorized loans of the digital content by the source terminal is modified, in the memorized digital content, according to at least one of: a number of recipient terminals to which the modified digital content is transmitted by the source terminal or the number of authorized loans of the digital content by the first recipient terminal.

6. The method for transmitting according to claim 1, wherein the modification of the digital content also comprises insertion, within said digital content, of a period of loan of the content, the first recipient terminal blocking access to the received content upon expiry of said period of loan.

7. The method for transmitting according to claim 1, wherein the modification of the digital content furthermore comprises insertion, within said digital content, of an identifier of the digital content and of an identifier of the first recipient terminal, the first recipient terminal giving access to the modified digital content according to said identifier of the first recipient terminal.

8. The method for transmitting according to claim 1, wherein the modification of the digital content also comprises insertion, within said digital content, of an identifier of the source terminal, the method furthermore comprising receipt by the source terminal of a notification from the first recipient terminal of termination of the loan by means of said identifier of the source terminal.

9. The method for transmitting according to claim 8, wherein the notification of termination of the loan is a message comprising the modified digital content.

10. The method for transmitting according to claim 1, wherein the insertion by the source terminal of the piece of data representing a number of authorized loans of the digital content by the first recipient terminal includes replacing, within the digital content, the piece of data representing a number of authorized loans of the digital content by the source terminal, by said piece of data representing the number of authorized loans of the digital content by the first recipient terminal.

11. The method for transmitting according to claim 1, wherein the method further comprises transmitting said modified digital content by the first recipient terminal to at least one second recipient terminal according to the piece of data representing the number of authorized loans of the digital content by the first recipient terminal.

12. A method for retransmission, comprising:
receiving, by a first recipient terminal, a digital content from a source terminal, said digital content containing a piece of data representing a number of authorized loans of said digital content by the first recipient terminal;
obtaining, by the first recipient terminal, from said digital content, said number of authorized loans of said digital content by the first recipient terminal; and
transmitting the digital content to at least one second recipient terminal according to said number of authorized loans of said digital content by the first recipient terminal.

13. The method according to claim 12, wherein the first recipient terminal sends the source terminal a request for authorizing the loan, the modified digital content being transmitted to the second recipient terminal only following reception, by the first recipient terminal, of a positive message of response to said request.

14. A terminal called a source terminal, which is configured for transmitting a digital content to at least one first recipient terminal, the digital content containing a piece of data representing a number of authorized loans of the digital content by the source terminal, this terminal comprising:
means for modifying the digital content comprising means of insertion, within said digital content, of a piece of data representing a number of authorized loans of the digital content by the first recipient terminal, which is smaller than the number of authorized loans of the digital content by the source terminal; and
means for transmitting the modified digital content to said at least one first recipient terminal.

15. A terminal, called a relay terminal, which is configured for retransmission to at least one recipient terminal, of a digital content received from a source terminal containing a piece of data representing a number of authorized loans of said digital content by said relay terminal, the relay terminal comprising:
means for obtaining, from the received digital content, said number of authorized loans of said digital content by the relay terminal; and
means for transmitting the digital content to said at least one recipient terminal according to said number of authorized loans of said digital content by the relay terminal.

16. (canceled)
